(19) United States
(12) Patent Application Publication
(10) Pub. No.: US 2022/0147155 A1
(43) Pub. Date: May 12, 2022

(54) KEYBOARDS WITH TOUCH-SENSITIVE PADS

(71) Applicant: Hewlett-Packard Development Company, L.P., Spring, TX (US)

(72) Inventor: Huan-Chen Liu, Taipei City (TW)

(73) Assignee: Hewlett-Packard Development Company, L.P., Spring, TX (US)

(21) Appl. No.: 17/297,961

(22) PCT Filed: Jul. 26, 2019
(86) PCT No.: PCT/US2019/043641

§ 371 Date: May 27, 2021

(51) Int. Cl. G06F 3/02; G06F 1/16

(52) U.S. Cl. CPC G06F 3/0213; G06F 1/169; G06F 1/1671

(57) ABSTRACT

Examples of keyboards with touch-sensitive pads are described herein. In an example, the keyboard includes a touch-sensitive pad to operate as a pointing device, the touch-sensitive pad being a non-depressible component

### BACKGROUND

Input devices such as keyboards are, generally, used for providing text input to a computing device. Over the years, the keyboards have undergone considerable evolution and are used for various other functionalities in addition to text input. For example, the keyboards are provided with function keys, numeric keypads, and navigation keys. With these evolutionary enhancements, amongst other things, a keyboard allows a user to navigate a graphical user interface (GUI) of the computing device and access a few selected functionalities, for instance, exploring a menu or selecting icons, from a full gamut of available functionalities.

### BRIEF DESCRIPTION OF FIGURES

The detailed description is provided with reference to the accompanying figures, wherein:

FIG. 1 illustrates a schematic of a computing device, according to an example;

FIG. 2A and FIG. 2B illustrate a keyboard of the computing device, according to an example;

FIG. 3A and FIG. 3B illustrate examples of the keyboard of the computing device;

FIG. 4 illustrates a schematic of a computing device, according to another example;

FIG. 5 illustrates a schematic of a computing device, according to one other example.

It should be noted that the description and the figures are merely examples of the present subject matter and are not meant to represent the subject matter itself. Throughout the drawings, identical reference numbers designate similar, but not identical, elements. The figures are not to scale, and the size of some parts may be exaggerated to more clearly illustrate the example shown. Moreover, the drawings provide examples and/or examples consistent with the description; however, the description is not limited to the examples and/or examples provided in the drawings.

### DETAILED DESCRIPTION

A keyboard may be unable to move a pointer and spatially explore the GUI. Accordingly, other input devices may be used to navigate and interact with the entire breadth of the GUI. Such other inputs devices can include add-on devices, for instance, a mouse, as well as built-in devices, such as a trackpad or a pointing stick (mini joystick), to move the pointer to any location on the GUI, and can be provided with buttons for providing commands, such as clicking on an icon, to the computing device. However, input devices, such as trackpads or pointing sticks, may not be ergonomically viable from a usage perspective. For example, users may repeatedly move their hands from the keyboard to the other input device and back, and may divert attention away from the screen, to effectively navigate the GUI. While few such movements of the hands and diversion of attention may seem inconsequential, there may be multiple such movements and diversions over a period of usage that may add up to a significant amount of consumed time and effort. In cases of input devices, such as trackpads and joysticks, positioned adjacent to the keyboard, such expenditure of time and effort may be alleviated to a certain extent, the user may still have to move the hands away from the keyboard and then re-position them resulting in loss of focus from the screen. Accordingly, such usage of input devices may be inefficient and laborious.

In a few computing devices, the input device may be designed as a trackpad incorporated on the surface of the spacebar key in the keyboard, to counter the inefficiency in usage of the trackpad. In such a case, the spacebar key being close to the thumb of the user may be ergonomically easy to use. In addition, in such input devices, the buttons for command inputs may also be provided on the surface of the spacebar key. However, during usage of the trackpad, the user may inadvertently press the spacebar key which can then create a conflict between use for pointer movement or command input and use for text input. In other cases, complicated mechanisms may have to be deployed or built-into the spacebar key to prevent such conflicting operations. However, such complicated mechanisms may involve additional equipment to be deployed along with the spacebar key and may, therefore, increase the cost of the computing device.

Examples of a keyboard having a touch-sensitive pad for use with a computing device, for example, operably connectable to the computing device, are described herein. The present subject matter describes, as an example, a keyboard designed to be ergonomic as well as effective in operation. The keyboard includes a body having a keypad portion and depressible keys accommodated in the keypad portion. The keyboard further includes a touch-sensitive pad provided in the keypad portion to operate as a pointing device, but as a non-depressible component. For instance, the touch-sensitive pad can operate as a touch-sensitive joystick provided separately from the various depressible keys on the keyboard.

In an example, a key of the keyboard is provided with a cavity which can accommodate the touch-sensitive pad that is non-depressible. In one instance, cavity can be in the form of a through hole in the key where the touch-sensitive pad is accommodated. In another instance, the key can be may include a first member and a second member, and the gap between the first member and the second member can form the cavity in which the touch-sensitive pad is located. With such a design of the touch-sensitive pad, the usage of the pointing device is convenient and user-friendly. For example, while using the touch-sensitive pad as the pointing device, the touch-sensitive pad is not inadvertently depressed, and it also does not conflict with the operation of other keys, for instance, the key, during operation.

Further, as mentioned above, the keyboard is operable along with the computing device and is, therefore, controllable by a controller of the computing device. According to said aspect, when the touch-sensitive pad is activated to operate as a pointing device, the controller can select a set of keys, such as a first key and a second key, from amongst the various keys of the keyboard to operate as buttons, for example, for clicking functionality, of the pointing device. For instance, when the user places a finger on the touch-sensitive pad to use it, the touch-sensitive pad can send an activation command to the controller to select and activate the set of keys on the keyboard based on the location of the set of keys relative to the key in which the pointing device is provided. Accordingly, the touch-sensitive pad can be designed to be a stand-alone touchpad without any buttons. This, in turn, allows the touch-sensitive pad to be accommodated easily in a considerably small space in the keypad portion of the keyboard, as explained above.

The above aspects are further described in conjunction with the figures, and in associated description below. It should be noted that the description and figures merely illustrate principles of the present subject matter. Therefore, various arrangements that encompass the principles of the present subject matter, although not explicitly described or shown herein, may be devised from the description and are included within its scope. Additionally, the word “coupled” is used throughout for clarity of the description and can include either a direct connection or an indirect connection.

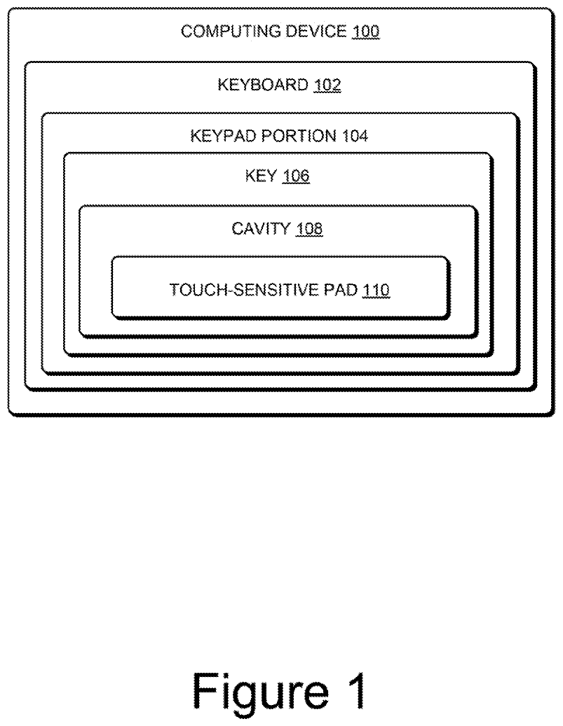

FIG. 1 illustrates a schematic of a computing device 100, according to an example of the present subject matter. In the present example, the computing device 100 can include a keyboard 102 having a keypad portion 104 which has a key 106 having a cavity 108. The keyboard 102 further includes a touch-sensitive pad 110 which is also provided in the keypad portion 104 to operate as a pointing device. According to an aspect of the present subject matter, the touch-sensitive pad 110 is a non-depressible component.

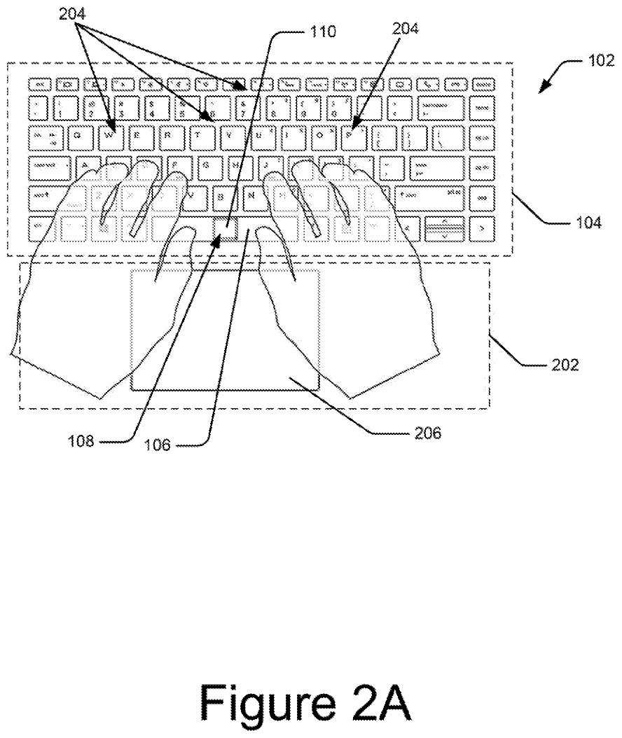

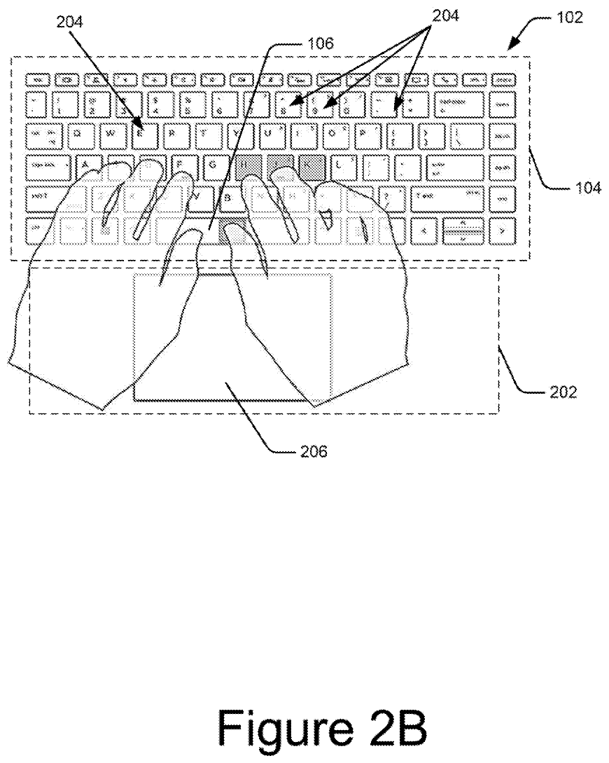

FIG. 2A and FIG. 2B illustrate the keyboard 102 of the computing device 100, according to one example of the present subject matter. While FIG. 2A illustrates a user using the keyboard 102 for typing, FIG. 2B illustrates a user using the touch-sensitive pad 110 of the keyboard 102 for pointer navigation. For the sake of brevity, FIG. 2A and FIG. 2B are described in conjunction.

As mentioned previously, the keyboard 102 includes the keypad portion 104 and the trackpad portion 202. The keypad portion 104 accommodates a plurality of depressible keys 204 while the trackpad portion 202 accommodates a trackpad 206 which can be used as a pointing device for the computing device 100. Further, the keypad portion 104 includes the touch-sensitive pad 110 which is also accommodated in the keypad portion 104 along with the depressible keys 204. The touch-sensitive pad 110 can function as the pointer device, in addition or as an alternative to the trackpad 206. For instance, in contrast to the trackpad 206, the touch-sensitive pad 110 may function as a touch-enabled joystick in which a small gesture of a digit of a user may cause a greater movement of the pointer on a graphical user interface (GUI) on a screen of the computing device 100.

In an example, the touch-sensitive pad 110 can be a capacitive surface coated with an insulator, such as glass, or a transparent conductor, such as indium tin oxide. In other example, the touch-sensitive pad 110 may use another tactile or non-contact sensing technology, including resistive, surface acoustic wave technology, infrared grid, infrared acrylic projection, optical imaging, dispersive signal technology, and acoustic pulse recognition. For instance, the type of touch-sensitive pad 110 used may be chosen based on supported gestures, cost, durability in various environments, precision, and other such factors.

According to an aspect shown in FIG. 2A and 26, the touch-sensitive pad 110 can be accommodated in the cavity 108 in the key 106. In an example, as shown in FIG. 2A and 2B, the touch-sensitive pad 110 can be accommodated in a spacebar key 106 of the keyboard 102. Accordingly, in said example, with the provision of the touch-sensitive pad 110 in such a key 106, the movements of digits of a user are minimal and, therefore, the user can switch between typing (FIG. 2A) and pointer navigation (FIG. 2B) intuitively, for instance, without looking away from a screen of the computing device. For example, as shown in FIG. 2B, the user may easily switch from typing to pointer navigation, and the key 106 can provide the guidance for the thumb to locate the cavity 108 in which the touch-sensitive pad 110 is accommodated. With minimal movement of the thumb, the thumb may naturally come to rest on the area of the key 106 where the touch-sensitive pad 110 is provided. Similarly, the user may find it convenient when switching back to typing from pointer navigation. As mentioned above, the user may not have to break their focus from the screen, making the typing and navigation experience fluent.

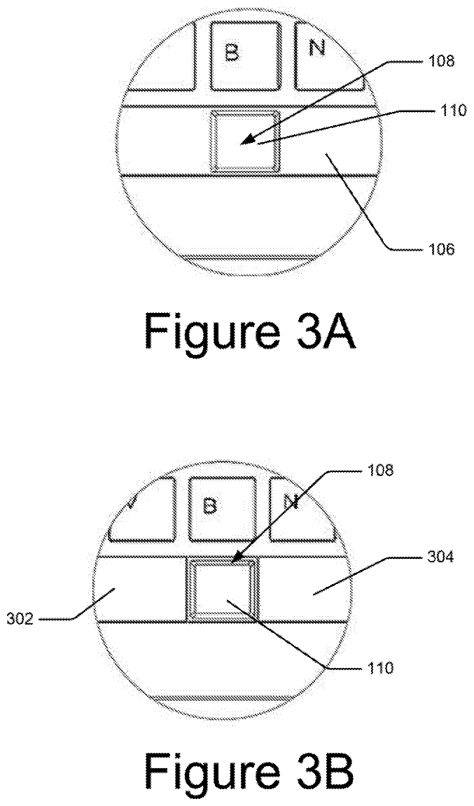

FIG. 3A and FIG. 38 illustrates examples of the keyboard 102 of the present subject matter. As mentioned previously, in said example, the key 106 is provided with the cavity 108 which can accommodate the touch-sensitive pad 110. FIG. 3A illustrates one example in which the cavity 108 can be in the form of a through-hole in the key 106 where touch-sensitive pad 110 is accommodated. In such a case, while the key 106 is depressible for text input to the computing device 100, the portion of the key 106 which accommodates the touch-sensitive pad 110 is not depressible to support the pointing functionality without hindering the operation of the key 106 for text input.

In another example, as shown in FIG. 38, the key 106 can be split along a length thereof into a left member 302 and a right member 304, and the gap between the left member 302 and the right member 304 can form the cavity 108 in which the touch-sensitive pad 110 can be accommodated located. With such a design, again, the usage of the pointing device does not interfere with the operation of the key 106. For example, use of the touch-sensitive pad 110 does not cause any depressing of the key 106, inadvertently or otherwise, since the touch-sensitive pad 110 is provided as a separate non-depressible component. In yet another example (not shown), the key 106 can be split along its width, in which case, the key can include a first member and a second member. For instance, the first member can be proximate to the trackpad portion 202 and the second member can be distal to the trackpad portion 202.

While the foregoing examples have been discussed with the touch-sensitive pad 110 accommodated in the spacebar key 106, alternatively, the touch-sensitive pad 110 can be accommodated in any other key among the depressible keys in the keyboard 102 which provides for an ergonomic use of the touch-sensitive pad 110. In another example, the touch-sensitive pad 110 may not be accommodated in any key, and, instead, may be accommodated in the keypad portion 104 in the space between the depressible keys 204. For instance, the touch-sensitive pad 110 may be accommodated in the space in which a pointing stick (mini joystick) is located in the keyboard 102. Other similar implementations are also envisaged by the present subject matter.

Further, as mentioned above, the keyboard 102 is operable along with the computing device 100 and is, therefore, controllable by the computing device 100 for operation. Accordingly, the touch-sensitive pad can be activated to operate as a pointing device, as discussed in detail further.

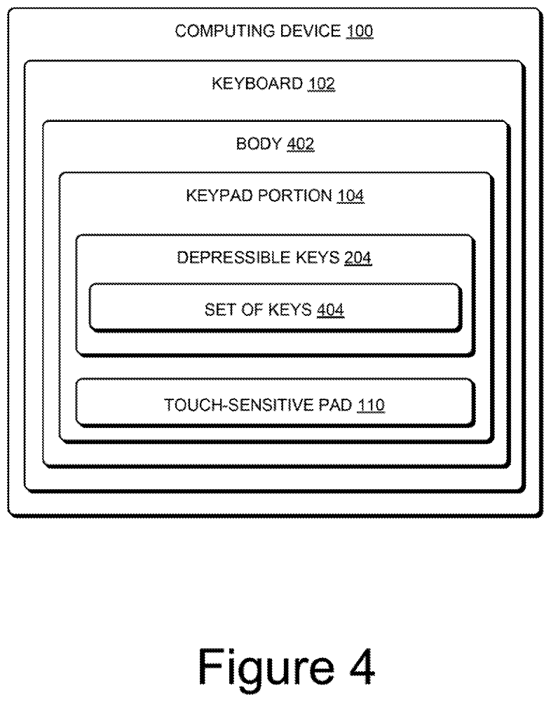

FIG. 4 illustrates a schematic of the computing device 100 having the keyboard 102, according to another example of the present subject matter. In said example, the keyboard 102 includes a body 402 having the keypad portion 104 which accommodates the plurality of depressible keys 204. The keyboard 102 also includes the touch-sensitive pad 110 is nested within a key 106 of the plurality of depressible keys 204, which, as mentioned above, is a non-depressible component and operates as a pointing device. Further, when the touch-sensitive pad 110 is activated, a set of keys 404 are selected from amongst the various depressible keys 204 to operate as buttons, for example, left-click and right click buttons, for the pointing device. In one example, the set of keys 404 are selected as buttons based on a location of the set of keys 404 relative to the key 106. For instance, in reference to the example in FIG. 1, where the touch-sensitive pad 110 is provided in the cavity 108 in the key 106, the set of keys 404 can be selected from any of the depressible keys 204 of the keyboard 102, except the key 106.

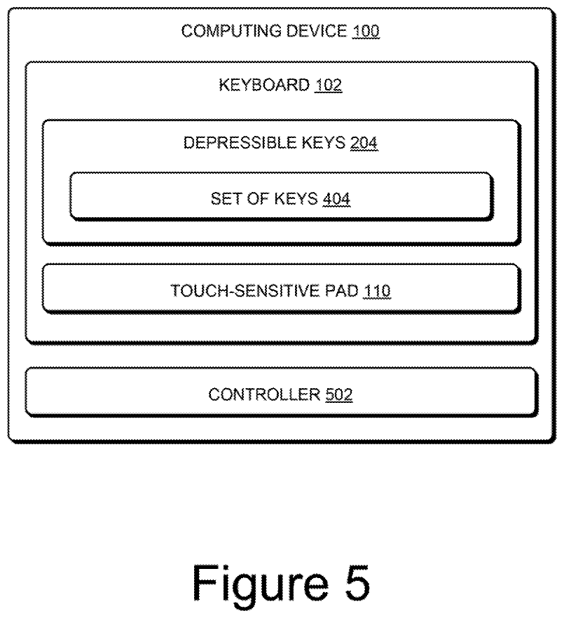

Further, FIG. 5 illustrates one other example of the computing device 100 of the present subject matter. In said example, in addition to the keyboard 102 having the depressible keys 204 and the touch-sensitive pad 110, the computing device may include the touch-sensitive pad 110 that may be nested within a spacebar key 106 of the plurality of depressible keys 204. For instance, the touch-sensitive pad 110 may be nested in a cavity 108 in the spacebar key 106. Further, the computing device 100 includes a controller 502 operably coupled to the keyboard 102. In operation, the controller 502 may change an input information associated with a set of keys 404, selected from amongst the plurality of depressible keys 204, in response to detecting an activation of the touch-sensitive pad 110. For instance, the controller 502 can receive an activation command from the touch-sensitive pad 110 in response to activation of the touch-sensitive pad.

In the various examples discussed above, for instance, discussed with reference to FIG. 4 and FIG. 5, the set of keys 404 may include a first key and the second key, and the input information may be modified from a text input or character input to an input associated with a pointing device. For instance, upon receipt of the activation command, in response to activation of the touch-sensitive pad 110, the controller 502 can select a first key and a second key from amongst the various depressible keys 204 to operate as buttons, for instance, the left-dick button and the right click button, for the pointing device.

For example, the first key and the second key are selected based on ergonomics and position of the first and the second key relative to the key 106 in which the touch-sensitive pad 110 is provided. Accordingly, in said example, the first key and the second key can be proximate to the touch-sensitive pad 110. For instance, the first and the second key are selected such that the distance between the touch-sensitive pad 110 and either of the selected keys is not greater than an average distance between the tip of the thumb and the tip of the index finger, for instance, for an average user. Such a selection allows for ergonomic use of the touch-sensitive pad 110 and the selected keys for use as pointing device and the buttons thereof. In one example, the controller 502 can select “H” button as the left-click button and the “J” button as the right-click button on the keyboard 102 for use as buttons for the touch-sensitive pad 110. In other examples, other keys of the keyboard may be selected for use as the left-click and right-click buttons for use with the touch-sensitive pad 110.

As explained earlier, even in the examples of FIGS. 4 and 5, the touch-sensitive pad 110 may be nested in middle of the spacebar key 106 of the keyboard 102, for instance, in a cavity 108 formed as a through-hole in the spacebar key 106. In one example, a spacebar key 106 may be split into a left spacebar key and a right spacebar key, and in said example, the cavity 108 is formed as a gap between the left spacebar key and the right spacebar key. In another example, the spacebar key 106 may be split along a middle along the width, as explained previously.

Although aspects of a keyboard 102 having a touch-sensitive pad 110 have been described in a language specific to structural features and/or methods, it is to be understood that the subject matter is not limited to the features or methods described. Rather, the features and methods are disclosed as examples of a keyboard 102 having a touch-sensitive pad 110.

We claim:

1. A computing device comprising:
a keyboard comprising:
a keypad portion comprising a key having a cavity; and
a touch-sensitive pad located in the cavity to operate as a pointing device, wherein the touch-sensitive pad is a non-depressible component.

2. The computing device as claimed in claim 1, wherein the cavity is formed as a through hole in the key.

3. The computing device as claimed in claim 1, wherein the key includes a first member and a second member, and wherein the cavity is formed as a gap between the first member and the second member.

4. The computing device as claimed in claim 1, further comprising a controller operably coupled to the keyboard, wherein the controller is to:
receive an activation command from the touch-sensitive pad in response to activation of the touch-sensitive pad; and
select a first key and a second key from amongst a plurality of depressible keys of the keyboard to operate as buttons for the pointing device, in response to activation of the touch-sensitive pad, wherein the first key and the second key are different from the key.

5. The computing device as claimed in claim 4, wherein the first key and the second key are proximate to the touch-sensitive pad.

6. A computing device comprising:
a keyboard comprising:
a plurality of depressible keys;
a body having a keypad portion to accommodate the plurality of depressible keys; and
a touch-sensitive pad nested within a key of the plurality of depressible keys to operate as a pointing device, wherein the touch-sensitive pad is a non-depressible component,
wherein a set of keys, from amongst the plurality of depressible keys, is selected to operate as buttons for the pointing device in response to activation of the touch-sensitive pad, and wherein the set of keys is selected based on a location of the set of keys relative to the key.

7. The computing device as claimed in claim 6, wherein the touch-sensitive pad is provided in a cavity in one of the plurality of depressible keys.

8. The computing device as claimed in claim 7, wherein the cavity is formed as a through hole in the key.

9. The computing device as claimed in claim 7, wherein the key includes a left member and a right member, and wherein the cavity is formed as a gap between the left member and the right member.

10. The computing device as claimed in claim 6, further comprising a controller operably coupled to the keyboard, wherein the controller is to receive an activation command from the touch-sensitive pad in response to activation of the touch-sensitive pad, and wherein the controller is to select the set of keys to operate as buttons for the pointing device.

11. A computing device comprising:
a keyboard comprising:
a plurality of depressible keys; and
a touch-sensitive pad nested within a spacebar key of the plurality of depressible keys, wherein the touch-sensitive pad is a non-depressible component; and
a controller operably coupled to the keyboard, wherein the controller is to, in response to detecting an activation of the touch-sensitive pad, change input information associated with a set of keys.

12. The computing device as claimed in claim 11, wherein the set of keys includes a first key and a second key, wherein the input information is changed from character input to input associated with a pointing device.

13. The computing device as claimed in claim 11, wherein the touch-sensitive pad is nested in the middle of the spacebar key.

14. The computing device as claimed in claim 13, wherein the touch-sensitive pad is nested in a cavity is formed as a through-hole in the spacebar key.

15. The computing device as claimed in claim 13, wherein the spacebar key is split into a left spacebar key and a right spacebar key, and wherein a cavity is formed as a gap between the left spacebar key and the right spacebar key.
